(19) United States
(12) Patent Application Publication
(10) Pub. No.: US 2014/0236624 A1
(43) Pub. Date: Aug. 21, 2014

(54) MANAGEMENT SYSTEM FOR PERSONAL HEALTH RECORD

(71) Applicants: Yoon Nyun Kim, Daegu (KR); Hyo Chan Jeon, Daegu (KR); Kyu Tae Choi, Daegu (KR)

(72) Inventors: Yoon Nyun Kim, Daegu (KR); Hyo Chan Jeon, Daegu (KR); Kyu Tae Choi, Daegu (KR)

(73) Assignee: MDWARE CO., LTD, Daegu (KR)

(21) Appl. No.: 13/392,848

(22) PCT Filed: Mar. 10, 2011
(86) PCT No.: PCT/KR11/01693

§ 371 Date: May 2, 2014

(30) Foreign Application Priority Data
Mar. 10, 2011 (KR) 10-2011-0021370

(51) Int. Cl. G06F 19/00

(52) U.S. Cl. CPC G06F 19/322
USPC 705/3

(57) ABSTRACT

The present disclosure relates to a management system for personal health record, and more particularly, to a management system for personal health record, which restricts an access to a personal health record according to user authentication, allows online and offline management of a personal health record, and provides multicasting.

The management system for personal health record includes: a first server providing a web service for managing personal health records; a second server connected to the first server to transmit/receive data to/from each other and storing data provided from the first server; a first unit provided being portable, accessing the web service that the first server provides through connection to an internet-enabled terminal, receiving measurement data from a measuring device that measures a personal bio signal and storing the received measurement data as private data, and managing the private data according to whether user authentication is successful or not; and a second unit accessing the web service that the first server provides via an internet network, and managing personal health records on a web site provided through the web service according to whether user authentication is successful or not. If it is determined that personal health records stored in the first unit and the second server are different from each other, the first server synchronizes the first unit and the second server with the latest data among the data stored in the first unit and the second server.

### TECHNICAL FIELD

The present disclosure relates to a management system for personal health record, and more particularly, to a management system for personal health record, which restricts an access to a personal health record according to user authentication, allows online and offline management of a personal health record, and provides multicasting.

### BACKGROUND ART

A personal health record includes a medical record on medical treatment in a hospital where medical experts practice, and in a broader range of a health record, also includes a health related record on blood glucose and blood pressure tested in a home by each individual, and an individual life record on drinking and smoking.

The personal health record includes individual disease-related information and a variety of personal information. Moreover, an amount of data regarding a personal health record becomes drastically increased because diverse treatments are taken as medical technology is rapidly advancing.

Since such an individual health record is both a record on personal health and personal information, it should be protected thoroughly, and in the case of a medical institution, used and referenced for fast treatment and appropriate medical service under his/her authentication or agreement.

Furthermore, because of various developments of communication environments, web pages for managing personal health records are provided via internet, so that the personal health records may be more efficiently managed.

However, the personal health records should not be misused by someone other than him/her or medical institutions, and be managed in online and offline.

Moreover, when a personal health record is to be used, a multicasting function needs to be provided that transmits data from a personal health record storing data server to at least one specific receiver who requests the personal health record.

### DISCLOSURE OF THE INVENTION

### Technical Problem

Embodiments provide a management system for personal health record, which restricts an access to a personal health record according to user authentication.

Embodiments also provide a management system for personal health record, which receives authentication information to manage a personal health record in online and offline, and manages the personal health record if user authentication is successful according to the received authentication information.

Embodiments also provide a management system for personal health record, which maintains the latest status by synchronizing a personal health record stored in online with a personal health record stored in offline.

Embodiments also provide a management system for personal health, which provides multicasting in online.

### Technical Solution

In one embodiment, a management system for personal health record includes: a first server providing a web service for managing personal health records; a second server connected to the first server to transmit/receive data to/from each other and storing data provided from the first server; a first unit provided being portable, accessing the web service that the first server provides through connection to an internet-enabled terminal, receiving measurement data from a measuring device that measures a personal bio signal and storing the received measurement data as private data, and managing the private data according to whether user authentication is successful or not; and a second unit accessing the web service that the first server provides via an internet network, and managing personal health records on a web site provided through the web service according to whether user authentication is successful or not. If it is determined that personal health records stored in the first unit and the second server are different from each other, the first server synchronizes the first unit and the second server with the latest data among the data stored in the first unit and the second server.

### Advantageous Effects

According to the management system for personal health record of the present invention having the above configuration, since a personal health record is accessible only by an authenticated user, leakage of personal heath records may be prevented.

Since leakage of personal health records is prevented, security may be improved while the management system for personal health record is in use, and personal health records may be managed in online and offline.

Moreover, since personal health records are managed in online and offline, efficiency of managing the personal health records may be improved.

Furthermore, since a personal health record is managed by him/her, he/she may continuously and stably take care of his/her health.

In addition, since personal health records are configured to be used simultaneously, or by several requestors, applicability and ease of use of the personal health records may be improved.

### BRIEF DESCRIPTION OF THE DRAWINGS

FIG. 1 is a schematic view illustrating an important configuration of a management system for personal health record according to an embodiment.

FIG. 2 is a block diagram illustrating a configuration of a management system for personal health record according to an embodiment.

FIG. 3 is a configuration view illustrating an operating state of a management system for personal health record through a first unit according to an embodiment.

FIG. 4 is a configuration view illustrating an operating state of a management system for personal health record through a second unit according to an embodiment.

FIG. 5 is a view illustrating a web page implemented by a management system for personal health record according to an embodiment.

FIG. 6 is a flowchart illustrating operations of a management system for personal health record through a first unit according to an embodiment.

FIG. 7 is a flowchart illustrating operations of a management system for personal health record through a second unit according to an embodiment.

### MODE FOR CARRYING OUT THE INVENTION

Hereinafter, a management system for personal health record according to the present invention will be described with reference to the accompanying drawings.

However, the scope of the present invention is not limited to embodiments below, and those skilled in the art may easily suggest other embodiments besides the embodiments below, but the other embodiments are also construed as being in the same technical scope of the present invention.

Furthermore, terms used in the specification or claims are selected for convenience of description, and thus, should be appropriately interpreted in correspondence to the technical scope of the present invention as understanding the technical contents of the present invention.

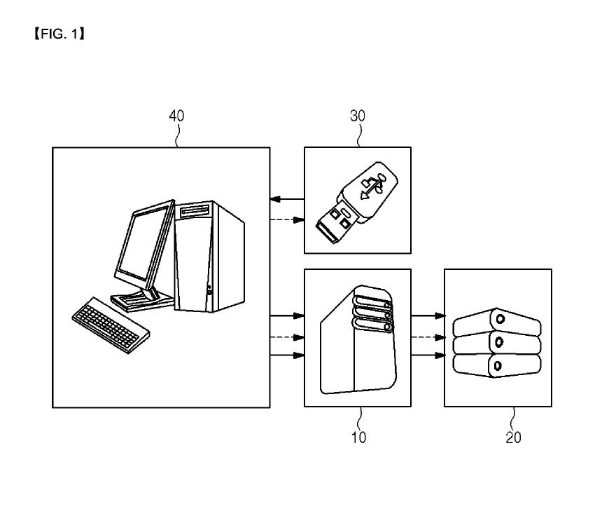

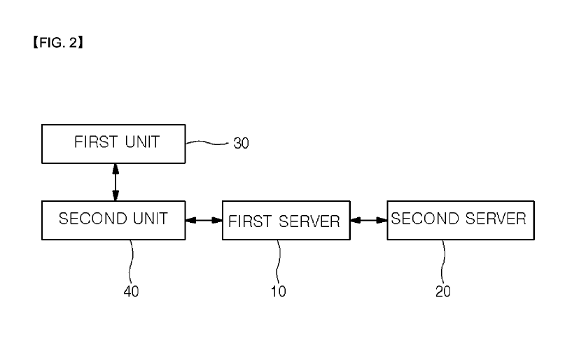

FIG. 1 is a schematic diagram illustrating an important configuration of a management system for personal health record according to an embodiment. FIG. 2 is a block diagram illustrating a configuration of a management system for personal health record according to an embodiment.

Referring to FIGS. 1 and 2, the management system for personal health record includes a first server 10 for providing a web service to manage personal health records generally, a second server 20 connected to the first server 10 to transmit/receive data to/from the first server 10 and store and manage data from the first server 10, a first unit 30 for receiving measurement data from a portable measuring device that measures a bio signal and storing them as private data, and a second unit 40 for managing personal health records in web sites provided from a web service that the first server 10 provides.

The first server 10 performs a function for providing a web service to manage personal health records via internet. The first server 10 compares and determines information inputted from an external with information stored in the second server, and then, performs the next operation.

In more detail, when a user accesses an internet web side through a terminal via internet, the first server 10 performs a web service.

That is, the first server 10 implements a web page, receives information that a user inputs on the web page, and compares and determines the received information with the data stored in the second server 20.

At this point, the first server 10 compares user information, which is inputted by a user on a web page, with the data stored in the second server 20 in order to perform a user authentication procedure.

If the user authentication is successful, a screen of a web page that a user demands is implemented by receiving the data stored in the second server 20, and if the user authentication is failed, a screen of a predetermined web page is implemented by receiving the data stored in the second server 20, or a screen of a web page displaying a user authentication failed state is implemented.

Moreover, the first server 10 is configured to have a multicasting function for transmitting the data stored in the second server 20 to at least one specific requestor that requests the data.

That is, the data stored in the second server 20 are configured to transfer only through the first server 10. When the data stored in the second server 20 are requested simultaneously or several requestors, a multicasting function for transmitting data simultaneously or to several requestors may be performed.

Since the first server 10 performs the multicasting function, a simultaneous or multiple access to the first server is possible so that the data stored in the second server 20 may be transmitted simultaneously or to several requestors through the first server 10.

Doing so, since the multicasting function is performed through the first server 10, personal health records stored in the second server 20 may be managed or used effortlessly.

Of course, when the data stored in the second server 20 are transmitted simultaneously or to several requestors through the first server 10, it is configured to transmit and receive data to and from only a requestor, who is authenticated after a user authentication procedure is successful.

The second server 20 stores a variety of information. The information includes data necessary for user authentication and a personal health record of a user. The second server 20 classifies information inputted through the first server 10 into public data (i.e., publicly available data) and private data (i.e., data provided to a user only when user authentication is successful), and stores them.

The public data stored in the second server 20 includes user basic information such as age, height, weight, and blood type, which is stored in a storage of the first unit 30.

The second server 20 is not connected to an external by itself, and transmit/receive data only through the first server 10. In more detail, the second server 20 is not directly connected to another internet or network, and is configured to only connect to the first server 10. This is for improving the stability of the data stored in the second server 20.

That is, even if the stability of the first server 10 is reduced due to hacking or virus infection, the data stored in the second server 20 may be safely protected.

The first unit 30 is portable, has a storage for storing predetermined data, and receives measurement data from a measuring device that measures a personal bio signal.

Moreover, the first unit 30 includes a public data storage for storing user basic information, i.e., publicly available data stored in the second server 20 and a private data storage for storing private data provided only when user authentication is successful.

The first unit 30 stores a personal bio signal, which is measured in the measuring device, in the private data storage and operates to view the measurement data only when user authentication is successful.

The first unit 30 accesses a web service that the first server 10 provides through an internet available terminal. At this point, the terminal may be a personal computer or a smart phone.

The first unit 30 has a program for implementing a web service, provided from the first server 10, on the screen of the terminal once accessing the terminal. Through the built-in program, a terminal that does not have a program for implementing a web service provided from the server 10 may operate using the first unit 30 in the same environment as the webpage of the web service provided from the first server 10.

If the first unit 30 is portable, has a predetermined storage, and performs a function for receiving measurement data measured in the measuring device, it may have any form.

However, in terms of availability, the first unit 30 may have a USB form or an IC card form. Of course, the first unit 30 may have another form, i.e., an RFID form.

The second unit 40 directly accesses a web server that the first server 10 provides via an internet network. If the second unit 40 directly accesses an internet network through a personal computer or a smart phone, it may have any form.

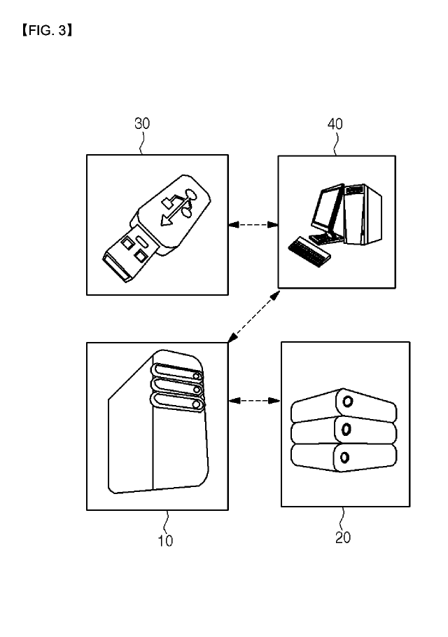

Hereinafter, a usage state of a management system for personal health record will be examined with reference to FIGS. 3 to 5.

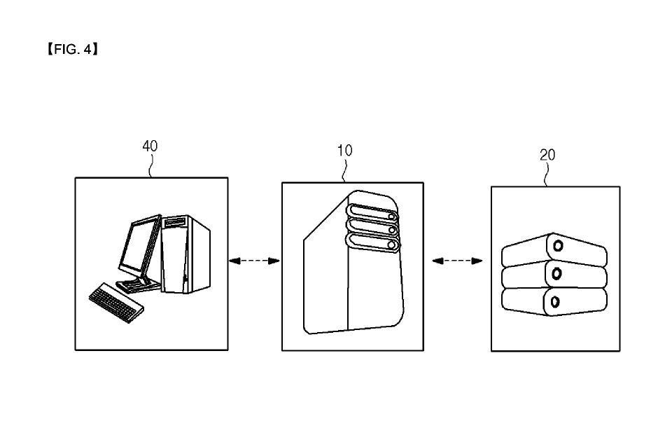

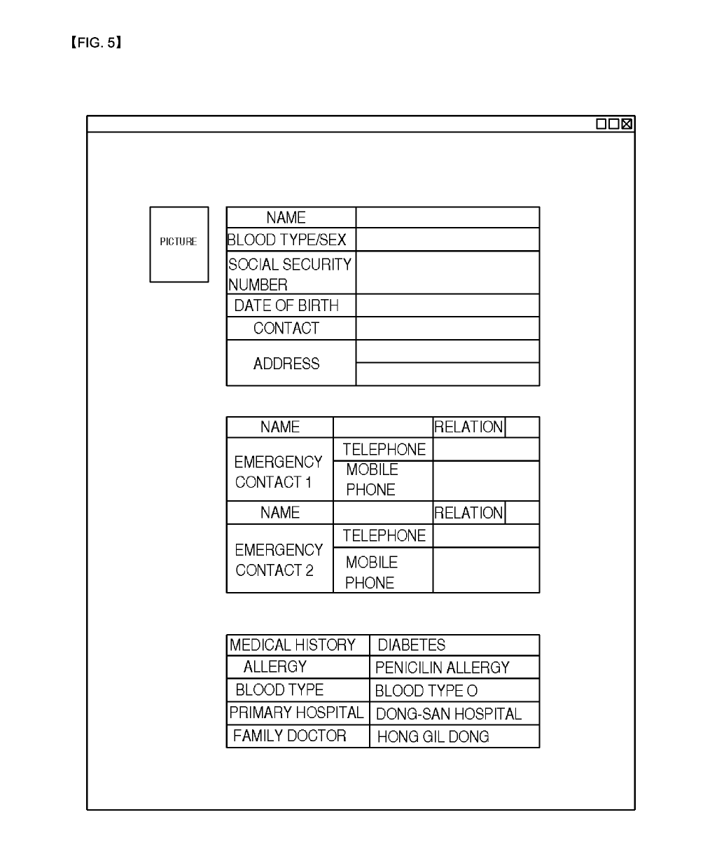

FIG. 3 is a configuration view illustrating an operating state through a first unit of a management system for personal health record according to an embodiment. FIG. 4 is a configuration view illustrating an operating state through a second unit of a management system for personal health record according to an embodiment. FIG. 5 is a view illustrating a web page implemented by a management system for personal health record according to an embodiment.

Looking at an operating state of a management system for personal health record through the first unit 30, a terminal needs to be provided that accesses an internet network in order to use the first unit 30.

This is to say, since the first unit 30 has no power and no configuration for transmitting data to an external, it receives power from a terminal that accesses an internet network, and transmits/receives data through the terminal.

A user connects the terminal to an internet network and then, connects the first unit 30 to the terminal. Once the first unit 30 accesses the terminal, the terminal is connected to the first server 10 via an internet network, and then, receives a web service from the first server 10.

At this point, a user may directly access the first server 10 through a web page implemented by a web service provided from the first server 10, or may access the first server 10 through a program stored in the first unit 30 after the first unit 30 accesses the terminal.

Of course, in order to use the first unit 30, the data stored in the first unit 30 may be used after user authentication is completed according to a user authentication procedure of the first unit 30.

When a web page provided from the first server 10 is displayed on the screen of the terminal, user authentication is performed again on the web page. This will improve security and protect personal health records simultaneously.

Once user authentication is successful, a web service from the first server 10 is provided, and through this web service, the personal health record stored in the first unit 30 is stored in the second server 20.

Of course, the data stored in the second server 20 may be stored in the first unit 30 through the first server 10.

That is, the personal health records may be managed by comparing the data stored in the second server 20 with the data stored in the first unit 30 and synchronizing them as the latest data.

Hereinafter, let's examine a configuration for managing a personal health record by using the second unit 40 not the first unit 30.

In order to configure the management system for personal health record of the present invention by using the second unit 40, the second unit 40 needs to be accessible to an internet network.

At this point, a user accesses to an internet network through the second unit 40. When the second unit 40 accesses the internet network, a web page implemented by a web service provided from the first server 10 is displayed on the screen of the second unit 40.

The first server 10 is configured to transmit/receive data to/from the second server 20. Through this configuration, a user receives a personal health record stored in the second server 20 through the second unit 40 and manages the personal health record.

If the user modifies the personal health record through the second unit 40, the modified data are transmitted to and stored in the second server 20 through the first server 10. By doing so, as the modified data are stored in the second server 20, the second server 20 maintains the latest data.

Of course, since the second server 20 stores all the previous data, a user understands a change of the personal health record. By doing so, the user understands a change of a personal health state and manages the personal health state.

Moreover, when a user accesses the first server 10 via an internet network by using the first unit 30 or the second unit 40, a web page of FIG. 5 is displayed on a screen of the terminal or the second unit 40.

Once the web page provided by the web service of the first server 10 is displayed on the screen of the terminal or the second unit 40, a user manages a personal health record by adding, modifying, and deleting the personal health record on the screen of the web page.

Personal medical history, blood type, allergic reaction, main hospital, and doctor are displayed as primary public data on the screen of the web page, and thus may be used for first aid treatment in emergency situations. Since faster first aid treatment is possible in emergency situations and appropriate first aid treatment to a patient is possible through the above public data, its efficiency may be improved.

Moreover, personal name, social security number, data of birth, contact, address, and emergency contact are displayed as secondary public data. When a specific condition is satisfied, the secondary public data are available for use.

The specific condition is that a certified professional agrees on storing an inquiry record when primary public data are displayed during an emergency situation. This specific condition may vary depending on situations or environments where a management system for personal health record is given.

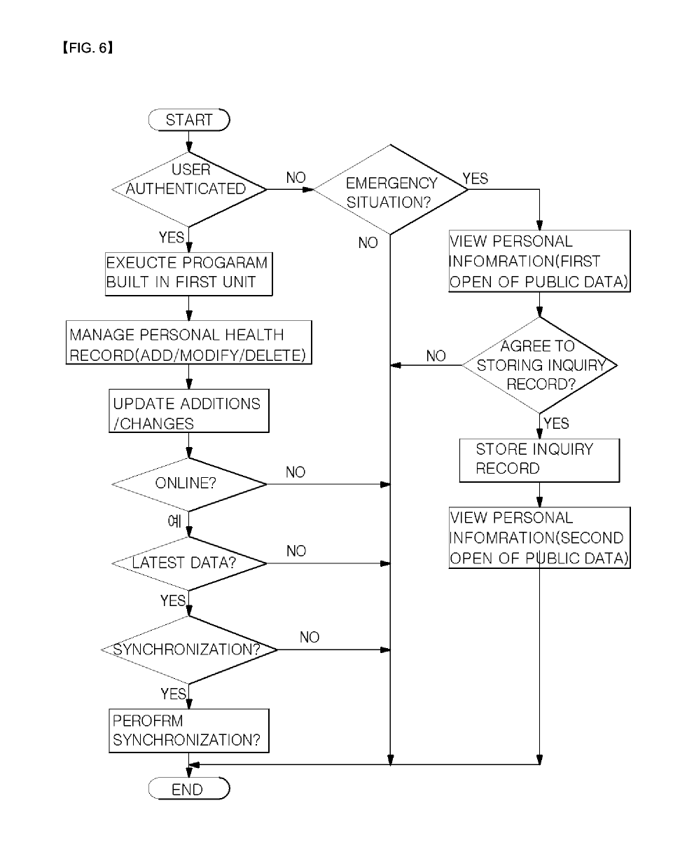

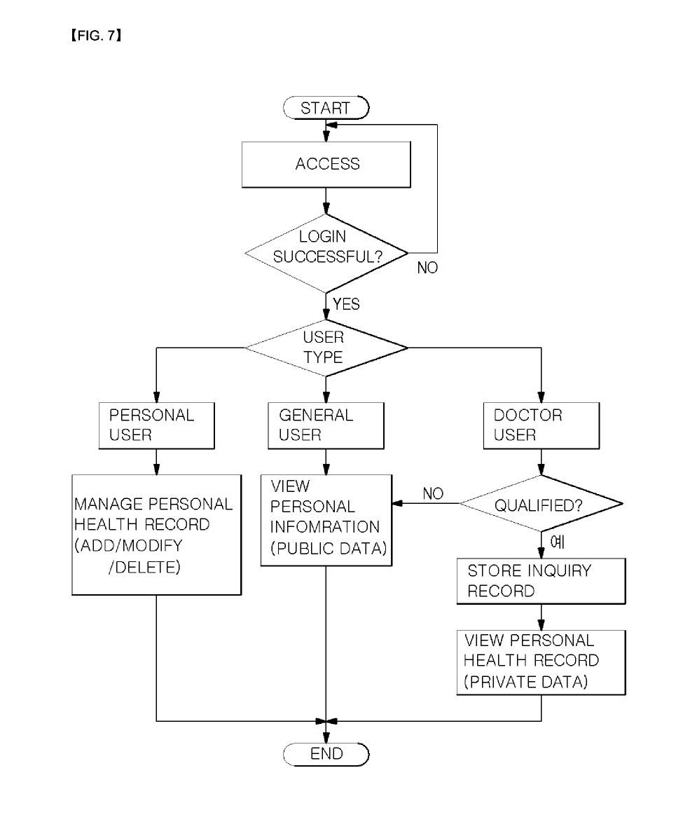

Hereinafter, operations of a management system for personal health record will be examined with reference to FIGS. 6 to 7.

FIG. 6 is a flowchart illustrating operations of a management system for personal health record through a first unit. FIG. 7 is a flowchart illustrating operations of a management system for personal health record through a second unit.

Referring to the drawings, in order to use the first unit 30, a user connects the first unit 30 to the terminal. Once the first unit 30 connects to the terminal, it determines whether power is applied or not.

If it is determined that the power is applied, the next operation is performed, and if it is determined that the poser is not applied, the use of the first unit 30 is terminated. If it is determined that the power is applied to the first unit 30, a user authentication procedure is performed.

The user authentication procedure determines whether to use the data stored in the first unit 30 by performing the user authentication procedure installed in the first unit 30.

According to an embodiment, a configuration that user authentication is performed through a fingerprint among bio information of a user will be examined as an example. Of course, iris recognition other than fingerprint is possible and other bio information recognitions are possible.

If user authentication is not successfully completed, it is determined whether the situation is an emergency or not. If the situation is not an emergency, the use of the first unit 30 is terminated, and if the situation is an emergency, primary public data, i.e., personal information, may be viewed.

Additionally, if a certified professional requests to view additional public data after viewing the primary public data, he/she may view secondary public data, i.e., personal information, if agreeing on storing his/her inquiry record.

If the user authentication is successfully completed, the program built in the first unit is executed, and then, the same web page as that of the web service provided from the first server 10 is displayed on the screen.

Once the web page is displayed on the screen of the terminal, a user authentication procedure is performed through the web page. At this point, only a user authentication procedure in the first unit 30 may be performed, but a user authentication procedure through a web page may not be performed, in terms of configuration.

In more detail, the user authentication procedure in the first unit 30 may be performed, and also a user authentication procedure on a web page displayed on the screen of the terminal may be performed. That is, a plurality of user authentication procedures may be performed in several operations.

Moreover, only a user authentication procedure in the first unit 30 may be performed, and a user may be identified on a web page displayed on the screen of the terminal, in terms of configuration.

Moreover, if private data stored in the first unit 30 are to be used, a user authentication procedure may be further performed, in terms of configuration.

Moreover, if a user authentication procedure is successfully completed, a web page in a user view state is displayed on the screen of the terminal. Once a web page of a user view is displayed, the data stored in the first unit 30 may be viewed by a user on the displayed web page.

Once a web page of a user view is displayed, it is possible to add, modify, and delete the data on the web page so that a user may mange a personal health record on the web page of the user view.

After the personal health record is managed, an update operation proceeds after confirming additions and changes. The additions and changes may include a contact or address change, an allergy status change, and a lifestyle change.

Once the stored personal health record data are provide to a user through the screen of the terminal, the user may view the personal health record data to confirm personal health and may manage the personal health record by adding, modifying, and deleting the stored personal health record.

Once the user finishes managing the personal health record on the web page, it is determined whether a state of the terminal is in an online state or an offline state.

If the state of the terminal is in an offline state, it proceeds to an operation for terminating the execution of the management system for personal health record, and then, its operation is terminated.

If the state of the terminal is in an online state, it is determined whether there are the latest data among the data stored in the first unit 30 and the data stored in the second server 20 through the first server 10.

At this point, if there are the latest data in one of the first unit 30 and the second server 20, it is determined whether to perform a synchronization operation to backup the data in the first unit 30 and the second server 20 as the latest data.

Once the synchronization operation is performed, since all the data stored in the first unit 30 and the second server 20 are backed up as the latest data, the first unit 30 and the second server 20 may now maintain the same latest data.

Once the synchronization operation is completed, it is determined whether to complete the use of the management system for personal health record, in order to determine whether to terminate the management system for personal health record.

However, if the user authentication procedure is not successfully completed, it is determined whether a current situation is an emergency situation or not. If the current situation is not an emergency situation, the management system for personal health record is terminated.

If the current situation is an emergency situation, even if user authentication is failed, it is configured that a user may view primary public data. Therefore, efficiency of first aid treatment may be improved.

If the current situation is an emergency situation, it is determined whether a user may have a first aid qualification. If not having a first aid qualification, the user may view primary public data.

If the user has a first aid qualification, an operation for verifying a license is performed. During the operation for verifying a license, it is possible to inquiry whether an organization issues the license by inputting a license number.

At this point, it is possible to verify a first aid qualification by inquiring a license number inputted from a user to the second server 20 that stores data on the license issue status of an organization that issues licenses. Or, it is possible to verify a first aid qualification by accessing an inquiry site of an organization that issues licenses to inquiry a license number.

As mentioned above, by verifying a license, leakage of personal health records is prevented, security is improved, and efficient first aid treatment becomes possible.

Moreover, once a first aid qualification is verified, the first server 10 allows only the secondary public data, i.e., personal health information, among the data stored in the second server 20 to be viewed by a user.

At this point, the first server 10 requesting an inquiry of the secondary public data determines whether there is an agreement on storing an inquiry record of a personal health record. If there is the agreement, the inquiry record is stored, and then, only the secondary public data, i.e., public data on personal health information, may be viewed.

Once an operation for viewing the secondary public data is completed, the management system for personal health record is terminated.

Hereinafter, an operating state of when a user uses a management system for personal health record through a second unit will be examined with reference to FIG. 7.

After a user drives the second unit 40 to access internet, a web page of a web service provided from the first server 10 is implemented. When user authentication is completed through a user authentication procedure by implanting the web page provided from the first server 10, the first server 10 implements a web page that a user uses, i.e., a personal web page, through a web service.

Once the personal web page is implanted in the second unit 40, a user may confirm his/her personal health record or may manage the personal health record provided from the first server 10.

At this point, the first server 10 may perform an additional security function. In more detail, if the web service provided from the first server is implanted while a user accesses an internet network through the second unit 40, the first server 10 implements a web page necessary for user authentication.

When the web page necessary for user authentication is implemented, a user performs a user authentication procedure (in more detail, a login operation). If the user authentication procedure is successfully completed, the first server 10 provides a web service for implementing a personal web page.

Moreover, if a user requests private data to confirm or manage a personal health record while the personal web page is implemented on the second unit 40, the first server 10 may provide a web service in order for another user to perform an authentication procedure.

That is, when a user requests private data, an authentication procedure different from a first user's authentication procedure is performed, so that leakage or misuse of personal health records may be prevented.

Moreover, the first server 10 is configured to have a multicasting function. Therefore, even when a plurality of the second units 40 are used in different places simultaneously, the first server 10 may be accessible and the personal health records may be available through the first server 10.

That is, since the first server 10 is configured to have a multicasting function, it is possible that a user accesses the first server 10 to manage his/her own personal health record, and also, a doctor, another professional, or other people approved by him/her may view the personal health record while he/she manages his/her own personal health record.

Furthermore, it is possible that a plurality of users may simultaneously access the first server 10 to manage their personal health records, and also doctors or hospitals may view personal health records to take care of patient's health after a plurality of users access the first server 10 simultaneously.

Moreover, if a user is a doctor, a web service executing a view for doctor is provided from the first server 10. Once the view for doctor is executed in the second unit 40, a doctor may confirm a personal health record of a corresponding patient so that accuracy and efficiency of medical treatment or prescription may be improved.

Moreover, if a user is a general user, a web service executing a general view is provided from the first server 10. The general view may be executed through various methods.

The general view implements a web page that allows a user to experience a web service provided from the first server 10, so that a user may virtually experience the web service provided from the first server 10. Therefore, the general view may be configured to be executed for advertising the web service provided from the first server 10 or managing personal health records.

In the same manner, since general users, doctors, and private users may simultaneously or separately access the first server 10 to take advantage of the data stored in the second server 20, so that availability and ease of use of personal health records may be improved.

The second server 20 includes user identification information and information on the use of personal health records. That is, if an identified user uses a personal health record, a usage record such as data type and data change is stored by each time.

That is, the reason for storing information of when an identified user uses a personal health record is that the information is used as information necessary for synchronization of the personal health record stored in the first unit 30.

That is, when the first unit 30 uses a personal health record through the first server 10, the data stored in the first unit 30 is compared to the data stored in the second server 20.

If there are the same data after comparing the data stored in the first unit 30 with the data stored in the second server 20, a user may select and use the data stored in the first unit 30 or the second server 20.

If there are different data after comparing the data stored in the first unit 30 with the data stored in the second server 20, a user may compare and determine the data stored in the first unit 30 and the second server 20, and then, may synchronize them with the latest data.

At this point, information regarding the synchronization is stored in the second server 20, and is used as comparison criteria during the next synchronization or the next data use.

Since the first unit 30 is synchronized with the second server 20, data stored in each storage may be maintained as the latest data, and personal health records may be smoothly managed.

The first server 10 may be configured to encode user's bio information and public data stored in the first unit 30 when they are inputted, and then, store them, and also may be configured to assign a password.

That is, encoding user's bio information and public data stored in the first unit 30 or assigning a password when they are inputted improves the security of the stored data by granting security during modification and synchronization of the first unit 30 and the second server 20.

### INDUSTRIAL APPLICABILITY

According to the management system of the present invention, leakage of personal health records may be prevented and personal health records may be managed without difficulties.

Due to the above various effects, the management system for personal health record may have a great availability for medical industries and various related industries.

1. A management system for personal health record, comprising:
a first server providing a web service for managing personal health records;
a second server connected to the first server to transmit/receive data to/from each other and storing data provided from the first server;
a first unit provided being portable, accessing the web service that the first server provides through connection to an internet-enabled terminal, receiving measurement data from a measuring device that measures a personal bio signal and storing the received measurement data as private data, and managing the private data according to whether user authentication is successful or not; and
a second unit accessing the web service that the first server provides via an internet network, and managing personal health records on a web site provided through the web service according to whether user authentication is successful or not,
wherein if it is determined that personal health records stored in the first unit and the second server are different from each other, the first server synchronizes the first unit and the second server with the latest data among the data stored in the first unit and the second server.

2. The management system for personal health record according to claim 1, wherein when it is determined that a user is not an authenticated user, the first unit displays a predetermined public personal health record on the web site that the first server provides, and when it is determined that the user is an authenticated user, the first unit displays the predetermined public personal health record and a private personal health record on the web site that the first server provides.

3. The management system for personal health record according to claim 1, wherein the first unit stores a program for implementing a web page provided from the first server, and manages a personal health record by using the web service that the first server provides through user authentication once power is applied to execute the program.

4. The management system according to claim 1, wherein the data stored in the second server are multicasted to at least one specific receiver who requests a personal health record in a data requiring area through the first server.

5. The management system for personal health record according to claim 1, wherein the second server is configured to transfer data only to the first server.
